(19) United States
(12) Patent Application Publication
(10) Pub. No.: US 2023/0252421 A1
(43) Pub. Date: Aug. 10, 2023

(54) System and Method for Crowd-Sourced Compensation

(71) Applicant: Payscale, Seattle, WA (US)

(72) Inventor: Sean HARRINGTON, Kirkland, WA (US)

(73) Assignee: Payscale, Seattle, WA (US)

(21) Appl. No.: 18/085,822

(22) Filed: Dec. 21, 2022

Related U.S. Application Data
(60) Provisional application No. 63/292,112, filed on Dec. 21, 2021.

(51) Int. Cl. G06Q 10/1053

(52) U.S. Cl. CPC G06Q 10/1053

(57) ABSTRACT

A method for crowd-sourced compensation ranging is provided, the method including, at least, (a) consideration of one or more of a candidate's base pay, bonus, and total annual compensation; (b) one or more of the candidate's job title and physical or virtual location; and (c) one or more experience-based compensable factors, including a candidate's specific skills, certifications, years of experience, and/or management roles.

### CROSS-REFERENCES TO RELATED APPLICATIONS

This patent application claims benefit of U.S. Patent Application No. 63/292,112, filed Dec. 21, 2021, the contents of which are hereby incorporated by reference in their entirety.

### FIELD

The present invention is drawn generally to systems and methods for crowd-sourced salary ranging, and in a particular though non-limiting embodiment to systems and methods that include consideration of all available compensable factors, including a plurality of crowd-sourced compensable factors.

### SUMMARY

The compensation systems and methods disclosed herein create pay distributions based on a plurality of provided compensable factors. thereby providing to a user a “snapshot” (or a “point in time” value) of the market for their specific job profile.

Example systems and methods systems for crowd-sourced compensation are provided that consider a candidate's base pay, bonus, and total yearly compensation; one or more of the candidate's job title and physical (or virtual) location; and a wide variety of other compensable factors, for example, the candidate's skills, certifications, years of experience, management role(s), education, and potentially countless other relevant factors.

In one example embodiment, fifty or more compensable factors are considered. In other embodiments, one-hundred or more compensable factors are considered.

Through a novel combination of different machine learning methods (specifically clustering and Bayesian networks, though other presently known and future devised AI might serve with equal efficacy), the systems and methods do not require all matching profiles to have the exact same compensable factors present. Therefore, even when data is sparse or missing—a common problem with survey data—the systems and methods can still make well-informed estimates based on the best data available.

### DETAILED DESCRIPTION

In an example embodiment, a system and method for compensation modeling is disclosed.

In one embodiment, the disclosure comprises a search system, which may (or may not) be proprietary, takes a set of inputs and restricts search space for the model by finding the most similar profiles with respect to a predefined distance and time, for example, the most similar 250 profiles defined within the last two years.

Ordinarily skilled artisans will readily appreciate that the number of considered filtering factors and their respective values (for example, a greater of fewer number of profiles and/or a period of greater or fewer number of years or months) are arbitrary, and do not limit the scope of the disclosure should different factors or values provide greater efficacy in a particular commercial application.

In another embodiment, a model with a complex distance metric (for example, a K-Nearest Neighbors model further comprising a complex distance metric) then selects a predefined number selected from the prior group of segregated profiles (for example, 45 of the most similar profiles from within the original set of 250 search profiles).

Again, ordinarily skilled artisans will readily appreciate that the actual reduced selection of profiles and their respective values (for example, a greater or fewer number of sub-selected profiles and/or a greater or fewer number of files from which they are sub-selected) are arbitrary, and do not limit to the scope of the disclosure should different factors or values provide greater efficacy in a particular application.

In a further embodiment, a probabilistic graphical model that represents conditional dependencies between random variables through a directed acyclic graph, for example, a Bayesian Belief Network, is directed toward all profile data from a predefined date forward (e.g., 2007 to present) to understand how each compensable factor influences pay (which will also contribute to the distance metric).

In a still further embodiment, the sub-selected profiles are fed into the expectation maximization (EM) algorithm. The EM algorithm is an iterative method to find (local) maximum likelihood or maximum a posteriori (MAP) estimates of parameters in statistical models, where the model depends on unobserved latent variables. The EM iteration alternates between performing an expectation (E) step, which creates a function for the expectation of the log-likelihood evaluated using the current estimate for the parameters, and a maximization (M) step, which computes parameters maximizing the expected log-likelihood found on the E step.

These parameter-estimates are then used to determine the distribution of the latent variables in the next E step to estimate a Double Pareto Log Normal (DPLN) distribution. A DPLN distribution is one of a family of probability densities proven useful in modelling the size distributions of various phenomenon, including incomes and earnings, human settlement sizes, oil-field volumes and particle sizes, for example.

In a further embodiment still, the EM algorithm is seeded with the prior data from the Bayesian Belief Network trained for that specific job and country combination. Finally, once the DPLN has been estimated, a report is created and rendered accessible to a user. In a yet another embodiment, the report contains a rating embodying confidence in the resulting prediction (for example a 1-10 rating or a 1-100 rating, or a comparative star rating system, etc.

Though the present invention is disclosed in detail herein with respect to several exemplary embodiments, those of ordinary skill in the art will also appreciate that minor changes to the description, and various other modifications, omissions and additions may also be made without departing from either the spirit or scope thereof.

1. A method for crowd-sourced compensation ranging, said method comprising consideration of one or more of a candidate's base pay, bonus, and total yearly compensation; one or more of the candidate's job title and physical or virtual location; and experience-based compensable factors including a candidate's skills, certifications, years of experience, and management roles.
